(19) United States
(12) Patent Application Publication
(10) Pub. No.: US 2020/0218279 A1
(43) Pub. Date: Jul. 9, 2020

(54) Robust Navigation of a Robotic Vehicle

(71) Applicant: QUALCOMM Incorporated, San Diego, CA (US)

(72) Inventors: Xiaohui LIU, Beijing (CN); Yibo JIANG, San Diego, CA (US); Lei XU, Beijing (CN); Yanming ZOU, Beijing (CN); Jiangtao REN, Beijing (CN)

(21) Appl. No.: 16/631,221

(22) PCT Filed: Aug. 30, 2017
(86) PCT No.: PCT/CN2017/099593

§ 371 Date: Jan. 15, 2020

(51) Int. Cl. G05D 1/02; G05D 1/00; G06T 7/579; G06T 7/246; G06T 7/73

(52) U.S. Cl. CPC G05D 1/0246; G05D 1/0274; G05D 1/0238; G06T 7/74; G06T 7/579; G06T 7/248; G05D 1/0094

(57) ABSTRACT

Various embodiments include processing devices and methods for navigation of a robotic vehicle. Various embodiments may include a rearward-facing image sensor mounted such that its plane angle aligns with a navigation plane of the robotic vehicle. In various embodiments, the image sensor of the robotic vehicle may capture images and a processor of the robotic vehicle may execute simultaneous localization and mapping (SLAM) tracking using the captured images. Embodiments may include a processor of the robotic vehicle determining whether the robotic vehicle is approaching a barrier. If the robotic vehicle is approaching a barrier, the processor may determine whether a rotation angle of the image sensor of the robotic vehicle exceeds a rotation threshold. If the rotation angle exceeds the rotation threshold then the processor may determine whether SLAM tracking is stable; and reinitialize a pose of the robotic vehicle in response to determining that SLAM tracking is not stable.

### BACKGROUND

Robotic vehicles are being developed for a wide range of applications. Robotic vehicles may be equipped with cameras capable of capturing an image, a sequence of images, or videos. Some robotic vehicles may be equipped with a monocular image sensor, such as a monocular camera. Captured images may be used by the robotic vehicle to perform vision-based navigation and localization. Vision-based localization and mapping provides a flexible, extendible, and low-cost solution for navigating robotic vehicles in a variety of environments. As robotic vehicles become increasing autonomous, the ability of robotic vehicles to detect and make decisions based on environmental features becomes increasingly important.

### SUMMARY

Various embodiments include methods that may be implemented on a processor of a robotic vehicle for robust navigation of the robotic vehicle. Various embodiments may include capturing images by a rearward-facing image sensor of the robotic vehicle, executing, by the processor, simultaneous localization and mapping (SLAM) tracking using the captured images, determining whether the robotic vehicle is approaching a barrier, determining whether a rotation angle of the image sensor of the robotic vehicle exceeds a rotation threshold in response to determining that the robotic vehicle is approaching a barrier, determining whether SLAM tracking is stable in response to determining that the rotation angle of the image sensor exceeds the rotation threshold, and reinitializing a pose of the robotic vehicle in response to determining that SLAM tracking is not stable.

In some embodiments, reinitializing the pose of the robotic vehicle may include identifying features in the captured images, selecting a captured image having a number of features exceeding a feature threshold, determining whether a number of tracked features of the selected image exceeds a tracking threshold, determining whether the distribution of the tracked features exceeds a distribution threshold in response to determining that the number of tracked features of the selected image exceeds a tracking threshold, and executing SLAM tracking in response to determining that the distribution of the tracked features exceeds a distribution threshold.

Some embodiments may include initializing a pose of the robotic vehicle by capturing an image of target objects, executing visual simultaneous localization and mapping (VSLAM) using the captured images of the target objects, determining whether the rotation angle of the image sensor can be determined, selecting a captured image having two or more target objects in a field of view of the image in response to determining that the rotation angle of the image sensor can be determined, and determining an image scale based, at least in part, on a location of the target objects within the selected image. Such embodiments may further include determining whether the selected image includes more than two target objects, and determining a rotation angle correction in response to determining that the selected image includes more than two target objects.

In such embodiments, the target objects may be spherical. In some embodiments, features may include physical terrain, contour, lighting, building fixtures and visual elements of an environment.

In some embodiments, executing SLAM tracking may include identifying features in the captured images, determining whether the identified features can be tracked between captured images, determining whether a number of mismatches in features between captured images is below a mismatch threshold in response to determining that the identified features can be tracked between captured images, and determining a pose of the robotic vehicle in response to determining that the number of mismatches in features between captured images is below the mismatch threshold.

In some embodiments, the rearward-facing image sensor may be mounted with short sides of the image sensor facing the front and rear of the robotic vehicle if a plane angle of the image sensor is small.

In some embodiments, the rearward-facing image sensor may be mounted with long sides of the image sensor facing the front and rear of the robotic vehicle if a plane angle of the image sensor is large.

Various embodiments may include a robotic vehicle having an image sensor and a processor configured with processor-executable instructions to perform operations of any of the methods summarized above. Various embodiments may include a processing device for use in a robotic vehicle configured to perform operations of any of the methods summarized above. Various embodiments may include a robotic vehicle having means for performing functions of any of the methods summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a system block diagram of a robotic vehicle operating within communication system according to various embodiments.

FIG. 2 is a component block diagram illustrating components of a robotic vehicle according to various embodiments.

FIG. 3 is a component block diagram illustrating a processing device suitable for use in robotic vehicles implementing various embodiments.

FIG. 4 is a component block diagram illustrating components of an image capture and processing system of a robotic vehicle suitable for use with various embodiments.

FIG. 5 is a system block diagram of a robotic vehicle during path planning according to various embodiments.

FIG. 6 is a system block diagram of a robotic vehicle initializing an image sensor according to various embodiments.

FIG. 7 is a process flow diagram illustrating a method of performing robust navigation by a robotic vehicle according to various embodiments.

FIG. 8 is a process flow diagram illustrating a method of reinitializing a pose of a robotic vehicle according to various embodiments.

FIG. 9 is a process flow diagram illustrating a method of initializing a pose of a robotic vehicle according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

In various embodiments, a robotic vehicle is configured with an image sensor may be mounted facing the rear of the robotic vehicle and may have its plane angle mounted in alignment with the navigation plane of the robotic vehicle. Mounting the image sensors facing the rear of the robotic vehicle may reduce the likelihood that the robotic vehicle will become lost when approaching or receding form a barrier. Various embodiments may also include methods implemented on a processor of the robotic vehicle for performing robust navigation by the robotic vehicle. Various embodiments may enable a processor of the robotic vehicle to initialize the pose of the robotic vehicle using a set of target objects in the form of domes or spheres located in a designated position on a barrier such as a wall. By taking pictures of spherical target objects, the robotic vehicle may be able to determine the location of the target object centers within the captured images, and determine a scale of the objects within the images. The robotic vehicle may then begin performing navigation techniques.

In various embodiments, a rear-ward facing image sensor of the robotic vehicle may capture images and a processor of the robotic vehicle may execute simultaneous localization and mapping (SLAM) tracking using the captured images. In various embodiments, a processor of the robotic vehicle may determine whether the robotic vehicle is approaching a barrier. If the robotic vehicle is approaching a barrier, the processor may determine whether a rotation angle of the image sensor of the robotic vehicle exceeds a rotation threshold. If the rotation angle exceeds the rotation threshold the processor may determine whether SLAM tracking is stable, and reinitialize a pose of the robotic vehicle in response to determining that SLAM tracking is not stable.

In various embodiments the processor of the robotic vehicle may identify features within the captured images. The processor may select a captured image having a number of features exceeding a feature threshold and determine whether a number of tracked features of the selected image exceeds a tracking threshold. If the number of tracked images exceeds the tracking threshold, then the processor may determine the distribution of the tracked features exceeds a distribution threshold and execute SLAM tracking in response to determining that the distribution of the tracked features exceeds a distribution threshold.

In various embodiments, the pose of the robotic vehicle may be initialized during startup of operations. For example, the image sensor may capture one or more images of target objects. These target objects may be domes, spheres, cones, pyramids, or other three dimensional objects protruding from a surface visible to the robotic vehicle. The processor of the robotic vehicle may execute visual simultaneous localization and mapping (VSLAM) using the captured images of the target objects. The processor may determine whether the rotation angle of the image sensor can be determined, and select a captured image having two or more target objects in a field of view of the image in response to determining that the rotation angle of the image sensor can be determined. The processor may determine or calculate an image scale based, at least in part, on a location of the target objects within the selected image. In various embodiments, the processor may also determine whether the selected image includes more than two target objects, and determine a rotation angle correction in response to determining that the selected image includes more than two target objects.

As used herein, the term “robotic vehicle” refers to one of various types of vehicles including an onboard processing device configured to provide some autonomous or semi-autonomous capabilities. Examples of robotic vehicles include but are not limited to: aerial vehicles, such as an unmanned aerial vehicle (UAV); ground vehicles (e.g., an autonomous or semi-autonomous car, a vacuum robot, etc.); water-based vehicles (i.e., vehicles configured for operation on the surface of the water or under water); space-based vehicles (e.g., a spacecraft or space probe); and/or some combination thereof. In some embodiments, the robotic vehicle may be manned. In other embodiments, the robotic vehicle may be unmanned. In embodiments in which the robotic vehicle is autonomous, the robotic vehicle may include an onboard computing device configured to maneuver and/or navigate the robotic vehicle without remote operating instructions (i.e., autonomously), such as from a human operator (e.g., via a remote computing device). In embodiments in which the robotic vehicle is semi-autonomous, the robotic vehicle may include an onboard computing device configured to receive some information or instructions, such as from a human operator (e.g., via a remote computing device), and autonomously maneuver and/or navigate the robotic vehicle consistent with the received information or instructions. In some implementations, the robotic vehicle may be an aerial vehicle (unmanned or manned), which may be a rotorcraft or winged aircraft. For example, a rotorcraft (also referred to as a multirotor or multicopter) may include a plurality of propulsion units (e.g., rotors/propellers) that provide propulsion and/or lifting forces for the robotic vehicle. Specific non-limiting examples of rotorcraft include tricopters (three rotors), quadcopters (four rotors), hexacopters (six rotors), and octocopters (eight rotors). However, a rotorcraft may include any number of rotors. A robotic vehicle may include a variety of components and/or payloads that may perform a variety of functions.

As used herein, the term “environmental features” refers to various types of terrain elements. Examples of environmental features include terrain contours, physical barriers, buildings, waterways, trees and other natural obstructions, temporary obstructions such as automobiles and other vehicles, illumination levels, weather effects, furniture, household items, office equipment, building fixtures, and the like. In some embodiments, environmental features may be those features detectable by a monocular image sensor of a robotic vehicle. In some embodiments, environmental features may be those features detectable by two or multi-image sensors. In some embodiments, environmental features may be features detectable by any sensor of the robotic vehicle such as ultrasound, infrared, binocular image sensors, etc.

Robotic vehicles may employ simultaneous localization and mapping (SLAM) techniques to construct and update a map of an unknown environment while simultaneously keeping track of the robotic vehicle's location within the environment. Robotic vehicles are increasingly equipped with image sensor devices for capturing images and video. In some embodiments, the image sensor device may include a monocular image sensor (e.g., a monocular camera). A robotic vehicle may gather data useful for SLAM using the image sensor device.

Robotic vehicles performing SLAM techniques are highly reliant on the presence of distinguishable features in the surrounding environment. A lack of recognizable or distinguishable features may cause localization and mapping operations to fail, and may result in the robotic vehicle becoming “lost” or otherwise unable to reach a target position. Although the navigation of many robotic vehicles is dependent upon distinguishing a variety of environmental features, existing techniques for robotic vehicle navigation fail to account for or prioritize the richness of available environmental features when navigating robotic vehicles. Most robotic vehicles select target positions and associated paths by identifying the closest desired position and determining the shortest, unobstructed path to that position.

Many robotic vehicles implementing SLAM techniques include forward facing cameras mounted on the top of the robotic vehicle with an upward angle of tilt. Additional sensors such as infrared, sonar, and pressure triggered bumpers are also mounted facing toward the front of the robotic vehicle. Consequently, moving patterns for most robotic vehicles include forward motion and in-place rotation. However, such robotic vehicles may encounter localization failures and become “lost” when approaching or leaving a barrier, such a wall, because the image sensor is not able to view enough of the barrier to properly identify location when close to the wall and while moving away from the wall. Environmental features being tracked in captured images (e.g., tracked features) may disappear quickly from the field of view as the robotic vehicle approaches and leaves a barrier. Further, forward facing image sensors may cause captured images to display a “warping effect. This warping effect may make determining the scale within images difficult at best.

Various embodiments may include an image sensor that is mounted on the robotic vehicle facing the rear of the robotic vehicle such that the camera faces away from the preferred travel direction of the vehicle. In some embodiments, the image sensor may also be mounted with an upward tilt. In some embodiments, the image sensor may be mounted in alignment with the navigation plane. This orientation of the image sensor may enable prolonged views of environmental features regardless of whether the camera is moving towards or away from a barrier. As the robotic vehicle moves in a forward direction, the rear of the robotic vehicle will be oriented in the same direction for a while, enabling a prolonged view of the same environmental features. Therefore, the robotic vehicle is less likely to become lost using SLAM while approaching a barrier compared to robotic vehicles with a forward facing image sensor. When moving away from a barrier, image sensor mounted facing the rear of the robotic vehicle may provide easier initialization and more accurate pose compared with facing the front, since all the features captured may be tracked in the following frames, and the distance is closer from features to the optical center of image sensor.

In various embodiments, the mounting of the image sensor may be aligned with the navigation plane of the robotic vehicle. Image sensors often have a rectangular shape and may be mounted on robotic vehicles in a variety of ways. The angle between the robotic vehicle navigation plane and the plane of images captured by the mounted image sensor is known as the plane angle. This plane angle may have a degree from 0-90. The image sensor may be mounted on the robotic vehicle so that the long or short sides of the rectangular image sensor are in alignment with the robotic vehicle's navigation plane based on the size of the image sensor's plane angle. For example, if the plane angle is large (small) enough, mount short (long) side of sensor along with robot moving direction. Mounting the image sensor in alignment with the navigation plane may provide more robust rotation and two dimensional reconstruction, as well as more robust translation. In various embodiments, when the plane angle is large, such as between 46-90 degrees, the short sides of the image sensor may be placed in alignment with the navigation plane of the robotic vehicle. For example, the image sensor may be mounted on the robotic vehicle so that the longest side of the image sensor faces the front and rear of the robotic vehicle. The benefits of such a mounting strategy may include improved tracking of features during robotic vehicle rotation and improved two-dimensional image reconstruction. Because the long side of the image sensor is facing the rear of the robotic vehicle, features will remain within the field of view for longer periods of time, thus providing additional data points. These points may be used to track features through images or create single images

When the plane angle is small, such as 0-45 degrees, the image sensor may be mounted on the robotic vehicle so that the long side of the rectangular image sensor aligns with the robotic vehicle navigation angle. Thus, the short sides of the rectangular image sensor may face the front and rear of the robotic vehicle. Benefits of such a mounting strategy may include improved tracking during translation of the robotic vehicle.

Various embodiments may also include replacing a target image for pose initialization with three dimensional objects such as spheres, domes, or cones that have rotation symmetry about an obvious center. Using three-dimensional objects with obvious “centers” may enable the processor of a robotic vehicle to easily calculate a scale correction regardless of the location and orientation of the robotic vehicle when viewing the target, thereby enabling the processor to determine the scale or objects within a captured image.

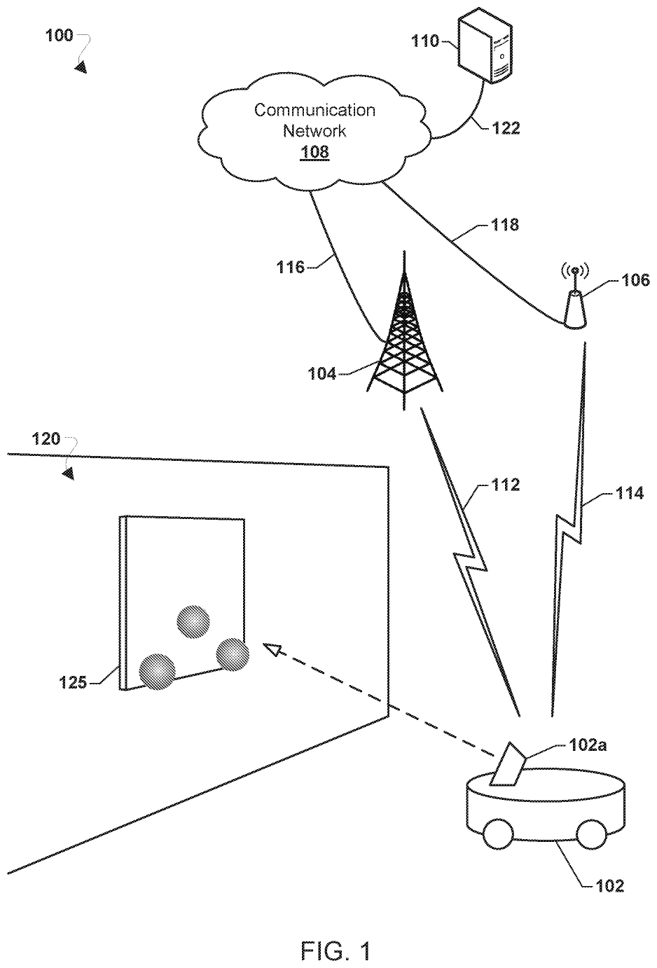

Various embodiments may be implemented within a robotic vehicle operating within a variety of communication systems 100, an example of which is illustrated in FIG. 1. With reference to FIG. 1, the communication system 100 may include a robotic vehicle 102, a base station 104, an access point 106, a communication network 108, and a network element 110. In some embodiments, the robotic vehicle 120 may be equipped with an image sensor 102a. In some embodiments, the image sensor 102a may include a monocular image sensor.

The base station 104 and the access point 106 may provide wireless communications to access the communication network 108 over a wired and/or wireless communication backhaul 116 and 118, respectively. The base station 104 may include base stations configured to provide wireless communications over a wide area (e.g., macro cells), as well as small cells, which may include a micro cell, a femto cell, a pico cell, and other similar network access points. The access point 106 may include access points configured to provide wireless communications over a relatively smaller area. Other examples of base stations and access points are also possible.

The robotic vehicle 102 may communicate with the base station 104 over a wireless communication link 112, and with the access point 106 over a wireless communication link 114. The wireless communication links 112 and 114 may include a plurality of carrier signals, frequencies, or frequency bands, each of which may include a plurality of logical channels. The wireless communication links 112 and 114 may utilize one or more radio access technologies (RATs). Examples of RATs that may be used in a wireless communication link include 3GPP Long Term Evolution (LTE), 3G, 4G, 5G, Global System for Mobility (GSM), Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

The network element 110 may include a network server or another similar network element. The network element 110 may communicate with the communication network 108 over a communication link 122. The robotic vehicle 102 and the network element 110 may communicate via the communication network 108. The network element 110 may provide the robotic vehicle 102 with a variety of information, such as navigation information, weather information, information about local air, ground, and/or sea traffic, movement control instructions, and other information, instructions, or commands relevant to operations of the robotic vehicle 102.

In various embodiments, the robotic vehicle 102 may move in an environment 120. In some embodiments, the robotic vehicle may use the image sensor 102a to capture one or more images of a set of target objects 125 in the environment 120. In some embodiments, the target objects 125 may include a three dimensional objects protruding from a wall or other barrier. The target objects 125 may include known characteristics, such as a height, a depth, and a width.

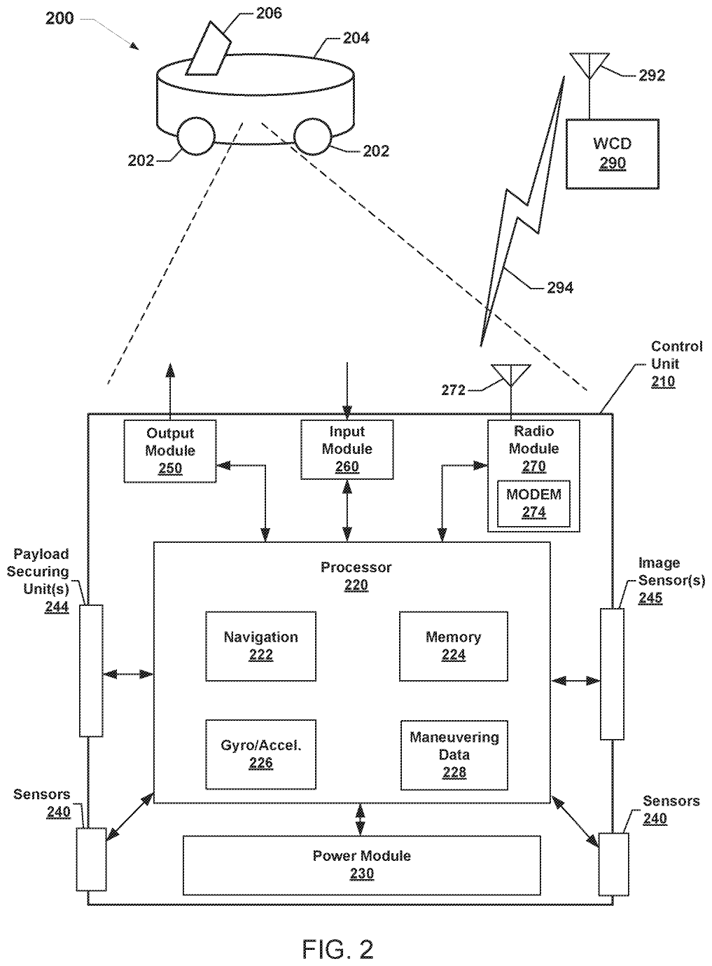

Robotic vehicles may include winged or rotorcraft varieties. FIG. 2 illustrates an example robotic vehicle 200 of a ground vehicle design that utilizes one or more wheels 202 driven by corresponding motors to provide locomotion to the robotic vehicle 200. The robotic vehicle 200 is illustrated as an example of a robotic vehicle that may utilize various embodiments, but is not intended to imply or require that various embodiments are limited to ground robotic vehicles. For example, various embodiments may be used with rotorcraft or winged robotic vehicles, water-borne robotic vehicles, and space-based robotic vehicles.

With reference to FIGS. 1 and 2, the robotic vehicle 200 may be similar to the robotic vehicle 102. The robotic vehicle 200 may include a number of wheels 202, a body 204, and an image sensor 206. The frame 204 may provide structural support for the motors and their associated wheels 202 as well as for the image sensor 206. For ease of description and illustration, some detailed aspects of the robotic vehicle 200 are omitted such as wiring, frame structure interconnects, or other features that would be known to one of skill in the art. While the illustrated robotic vehicle 200 has wheels 202, this is merely exemplary and various embodiments may include any variety of components to provide propulsion and maneuvering capabilities, such as treads, paddles, skids, or any combination thereof or of other components.

The robotic vehicle 200 may further include a control unit 210 that may house various circuits and devices used to power and control the operation of the robotic vehicle 200. The control unit 210 may include a processor 220, a power module 230, sensors 240, one or more payload securing units 244, one or more image sensors 245, an output module 250, an input module 260, and a radio module 270.

The processor 220 may be configured with processor-executable instructions to control travel and other operations of the robotic vehicle 200, including operations of various embodiments. The processor 220 may include or be coupled to a navigation unit 222, a memory 224, a gyro/accelerometer unit 226, and a maneuvering data module 228. The processor 220 and/or the navigation unit 222 may be configured to communicate with a server through a wireless connection (e.g., a cellular data network) to receive data useful in navigation, provide real-time position reports, and assess data.

The maneuvering data module 228 may be coupled to the processor 220 and/or the navigation unit 222, and may be configured to provide travel control-related information such as orientation, attitude, speed, heading, and similar information that the navigation unit 222 may use for navigation purposes, such as dead reckoning between Global Navigation Satellite System (GNSS) position updates. The gyro/accelerometer unit 226 may include an accelerometer, a gyroscope, an inertial sensor, an inertial measurement unit (IMU), or other similar sensors. The maneuvering data module 228 may include or receive data from the gyro/accelerometer unit 226 that provides data regarding the orientation and accelerations of the robotic vehicle 200 that may be used in navigation and positioning calculations, as well as providing data used in various embodiments for processing images.

The processor 220 may further receive additional information from one or more image sensors 245 (e.g., a camera, which may be a monocular camera) and/or other sensors 240. In some embodiments, the image sensor(s) 245 may include an optical sensor capable of infrared, ultraviolet, and/or other wavelengths of light. The sensors 240 may also include a wheel sensor, a radio frequency (RF) sensor, a barometer, a sonar emitter/detector, a radar emitter/detector, a microphone or another acoustic sensor, or another sensor that may provide information usable by the processor 220 for movement operations as well as navigation and positioning calculations. The sensors 240 may include contact or pressure sensors that may provide a signal that indicates when the robotic vehicle 200 has made contact with a surface. The payload-securing units 244 may include an actuator motor that drives a gripping and release mechanism and related controls that are responsive to the control unit 210 to grip and release a payload in response to commands from the control unit 210.

The power module 230 may include one or more batteries that may provide power to various components, including the processor 220, the sensors 240, the payload-securing unit(s) 244, the image sensor(s) 245, the output module 250, the input module 260, and the radio module 270. In addition, the power module 230 may include energy storage components, such as rechargeable batteries. The processor 220 may be configured with processor-executable instructions to control the charging of the power module 230 (i.e., the storage of harvested energy), such as by executing a charging control algorithm using a charge control circuit. Alternatively or additionally, the power module 230 may be configured to manage its own charging. The processor 220 may be coupled to the output module 250, which may output control signals for managing the motors that drive the rotors 202 and other components.

The robotic vehicle 200 may be controlled through control of the individual motors of the rotors 202 as the robotic vehicle 200 progresses toward a destination. The processor 220 may receive data from the navigation unit 222 and use such data in order to determine the present position and orientation of the robotic vehicle 200, as well as the appropriate course towards the destination or intermediate sites. In various embodiments, the navigation unit 222 may include a GNSS receiver system (e.g., one or more global positioning system (GPS) receivers) enabling the robotic vehicle 200 to navigate using GNSS signals. Alternatively or in addition, the navigation unit 222 may be equipped with radio navigation receivers for receiving navigation beacons or other signals from radio nodes, such as navigation beacons (e.g., very high frequency (VHF) omni-directional range (VOR) beacons), Wi-Fi access points, cellular network sites, radio station, remote computing devices, other robotic vehicles, etc.

The radio module 270 may be configured to receive navigation signals, such as signals from aviation navigation facilities, etc., and provide such signals to the processor 220 and/or the navigation unit 222 to assist in robotic vehicle navigation. In various embodiments, the navigation unit 222 may use signals received from recognizable RF emitters (e.g., AM/FM radio stations, Wi-Fi access points, and cellular network base stations) on the ground.

The radio module 270 may include a modem 274 and a transmit/receive antenna 272. The radio module 270 may be configured to conduct wireless communications with a variety of wireless communication devices (e.g., a wireless communication device (WCD) 290), examples of which include a wireless telephony base station or cell tower (e.g., the base station 104), a network access point (e.g., the access point 106), a beacon, a smartphone, a tablet, or another computing device with which the robotic vehicle 200 may communicate (such as the network element 110). The processor 220 may establish a bi-directional wireless communication link 294 via the modem 274 and the antenna 272 of the radio module 270 and the wireless communication device 290 via a transmit/receive antenna 292. In some embodiments, the radio module 270 may be configured to support multiple connections with different wireless communication devices using different radio access technologies.

In various embodiments, the wireless communication device 290 may be connected to a server through intermediate access points. In an example, the wireless communication device 290 may be a server of a robotic vehicle operator, a third party service (e.g., package delivery, billing, etc.), or a site communication access point.

The robotic vehicle 200 may communicate with a server through one or more intermediate communication links, such as a wireless telephony network that is coupled to a wide area network (e.g., the Internet) or other communication devices. In some embodiments, the robotic vehicle 200 may include and employ other forms of radio communication, such as mesh connections with other robotic vehicles or connections to other information sources (e.g., balloons or other stations for collecting and/or distributing weather or other data harvesting information).

In various embodiments, the control unit 210 may be equipped with an input module 260, which may be used for a variety of applications. For example, the input module 260 may receive images or data from an onboard camera or sensor, or may receive electronic signals from other components (e.g., a payload).

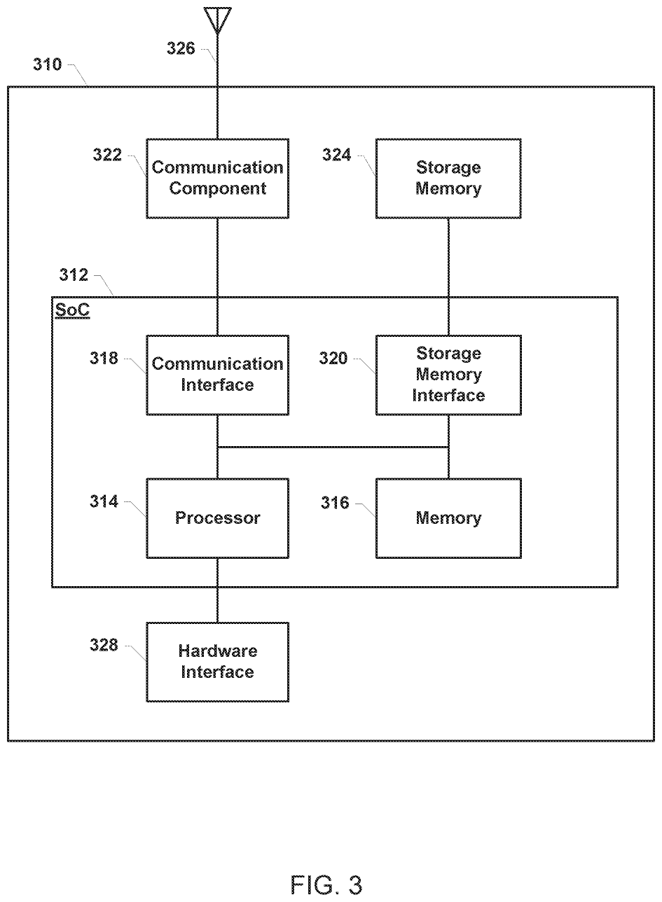

While various components of the control unit 210 are illustrated in FIG. 2 as separate components, some or all of the components (e.g., the processor 220, the output module 250, the radio module 270, and other units) may be integrated together in a single processing device 310, an example of which is illustrated in FIG. 3.

With reference to FIGS. 1-3, the processing device 310 may be configured to be used in a robotic vehicle and may be configured as or including a system-on-chip (SoC) 312. The SoC 312 may include (but is not limited to) a processor 314, a memory 316, a communication interface 318, and a storage memory interface 320. The processing device 310 or the SoC 312 may further include a communication component 322, such as a wired or wireless modem, a storage memory 324, an antenna 326 for establishing a wireless communication link, and/or the like. The processing device 310 or the SoC 312 may further include a hardware interface 328 configured to enable the processor 314 to communicate with and control various components of a robotic vehicle. The processor 314 may include any of a variety of processing devices, for example any number of processor cores.

The term “system-on-chip” (SoC) is used herein to refer to a set of interconnected electronic circuits typically, but not exclusively, including one or more processors (e.g., 314), a memory (e.g., 316), and a communication interface (e.g., 318). The SoC 312 may include a variety of different types of processors 314 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SoC 312 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SoC 312 may include one or more processors 314. The processing device 310 may include more than one SoC 312, thereby increasing the number of processors 314 and processor cores. The processing device 310 may also include processors 314 that are not associated with a SoC 312 (i.e., external to the SoC 312). Individual processors 314 may be multicore processors. The processors 314 may each be configured for specific purposes that may be the same as or different from other processors 314 of the processing device 310 or SoC 312. One or more of the processors 314 and processor cores of the same or different configurations may be grouped together. A group of processors 314 or processor cores may be referred to as a multi-processor cluster.

The memory 316 of the SoC 312 may be a volatile or non-volatile memory configured for storing data and processor-executable instructions for access by the processor 314. The processing device 310 and/or SoC 312 may include one or more memories 316 configured for various purposes. One or more memories 316 may include volatile memories such as random access memory (RAM) or main memory, or cache memory.

Some or all of the components of the processing device 310 and the SoC 312 may be arranged differently and/or combined while still serving the functions of the various aspects. The processing device 310 and the SoC 312 may not be limited to one of each of the components, and multiple instances of each component may be included in various configurations of the processing device 310.

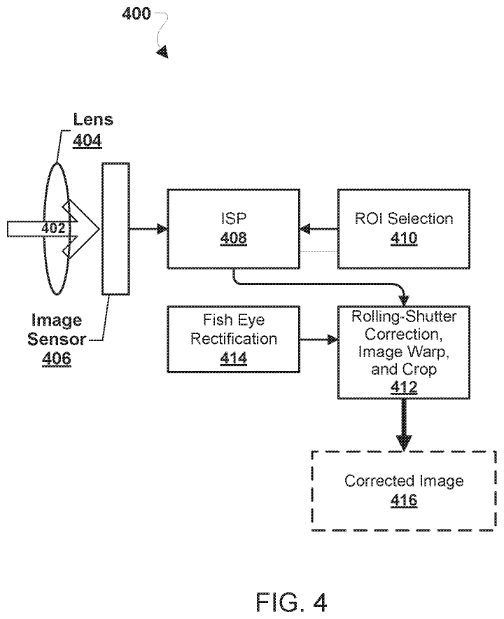

FIG. 4 illustrates an image capture and processing system 400 of a robotic vehicle suitable for use with various embodiments. With reference to FIGS. 1-4, the image capture and processing system 400 may be implemented in hardware components and/or software components of the robotic vehicle, the operation of which may be controlled by one or more processors (e.g., the processor 220, the processing device 310, the SoC 312, and/or the like) of the robotic vehicle.

An image sensor 406 may capture light of an image 402 that enters through a lens 404. The lens 404 may include a fish eye lens or another similar lens that may be configured to provide a wide image capture angle. The image sensor 406 may provide image data to an image signal processing (ISP) unit 408. A region of interest (ROI) selection unit 412 may provide data to the ISP 408 data for the selection of a region of interest within the image data. In some embodiments, the image sensor 406 may be similar to the image sensor 102a, 245.

The ISP 408 may provide image information and ROI selection information to a rolling-shutter correction, image warp, and crop unit 412. A fish eye rectification unit 414 may provide information and/or processing functions to the rolling-shutter correction, image warp, and crop unit 412. In some embodiments, the image rectification unit 414 may provide information and/or processing functions to correct for image distortion caused by the lens 404, an image distortion effect caused by the image sensor 406 (e.g., distortion such as wobble, skew, smear, and the like), or other image distortion.

The rolling-shutter correction and warp unit 412 may provide as output a corrected image 416 based on the cropping, distortion correction, and/or application of the transformation matrix. In some embodiments, the corrected image may include an image having a corrected horizontal orientation or horizontal rotation. In some embodiments, the corrected image may include a stabilized video output.

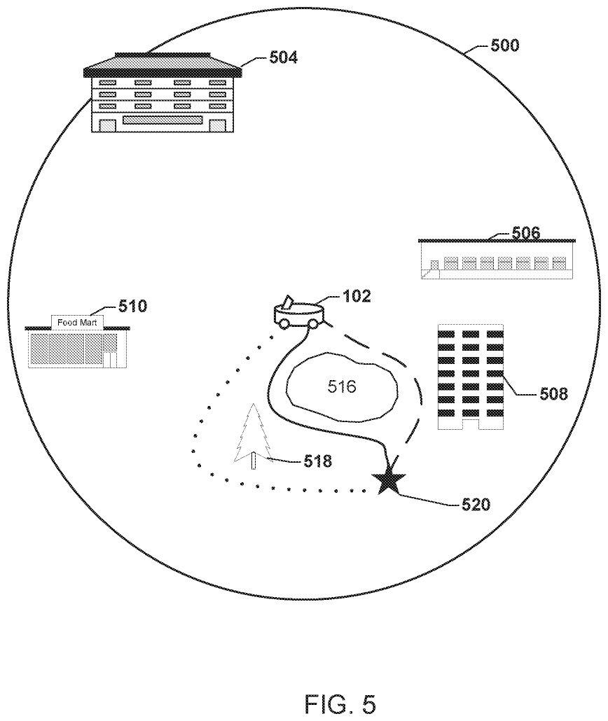

FIG. 5 illustrates an exploration area 500 to be explored by a robotic vehicle (e.g., 102, 200 in FIGS. 1 and 2) suitable for use with various embodiments. With reference to FIGS. 1-5, the robotic vehicle 102 may navigate within an exploration region 500. Various structures such as buildings 504, 506, 508, and 510, as well as a lake 516 and a tree 518, may present environmental features that may be tracked by the robotic vehicle through a comparison of captured images. Different navigation paths, illustrated by the dashed, dotted, and solid lines connected to the target position (star) 520 may bring the robotic vehicle image sensor into view of different environmental features. Similarly, if the robotic vehicle is located indoors, the features may include office equipment, furniture, building fixtures, home items, flooring patterns, or other visually distinguishable elements of the environment that might be used for path planning.

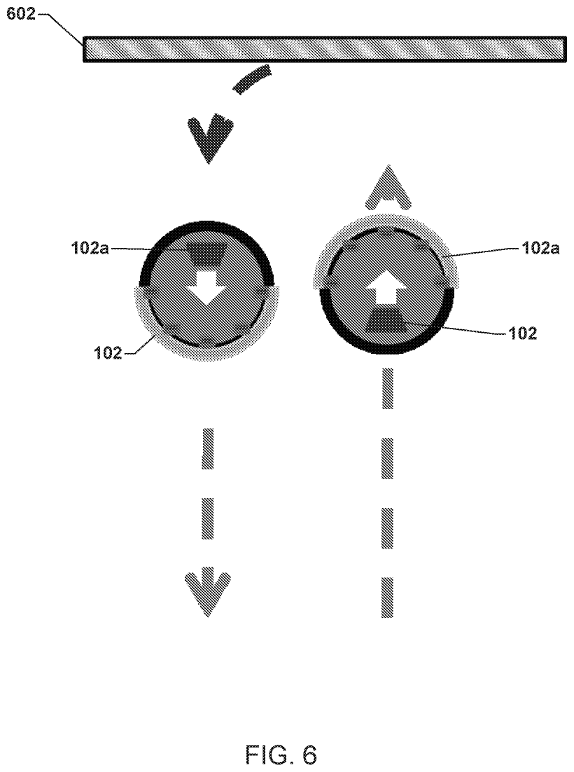

FIG. 6 illustrates a robotic vehicle performing SLAM suitable for use with various embodiments. With reference to FIGS. 1-6, the processor of the robotic vehicle 102 may guide the robotic vehicle towards a barrier such as a wall 602. As the robotic vehicle 102 approaches the wall 602, the rearward facing image sensor 102a may capture images behind the robotic vehicle and use those images to continue executing SLAM tracking. Because the image sensor 102a may have a prolonged view of the surrounding environment, the captured images may include numerous environmental features. The processor may track these features as part of SLAM navigation. Thus, SLAM tracking may remain stable as the robotic vehicle 102 approaches a wall 602. In contrast, if the image sensor were facing the front of the robotic vehicle, features on the wall 602 would quickly move out of the field of view as the robotic vehicle 102 approached the wall 602, leading to the processor becoming “lost” due to insufficient

When the robotic vehicle 102 turns away from the wall 602, the proximity of the barrier to the rearward-facing image sensor 102a may render SLAM unstable, causing the robotic vehicle 102 to become lost or disoriented momentarily. The barrier may be too close to the image sensor for proper resolution of the barrier's details. Thus, the robotic vehicle 102 may have difficulty in performing SLAM tracking using the features included in images captured near the receding barrier 602 immediately after turning away from the wall 602. However, as the robotic vehicle 102 moves away from the barrier 602, the features on the wall 602 will come into view of the rearward facing image sensor 102a.

As the robotic vehicle 102 recedes from the barrier 602, the details of the barrier may again come into focus for the image sensor 102. This may enable the processor to again identify and track features displayed in captured images. Thus, SLAM navigation may again be stable. As illustrated in FIG. 6, the portions of the robotic vehicle 102 trajectory depicted in light grey dotted line may be those portions of the trajectory for this SLAM navigation is not problematic. The portions of the trajectory that are depicted in a dark grey dotted line may be difficult to navigate due to the proximity of the barrier 602 to the robotic vehicle 102.

In this way, various embodiments may increase the percentage of time that a robotic vehicle is able to maintain stable SLAM navigation by presenting a rearward facing image sensor. In order to further improve navigation accuracy, the sides of the rectangular image sensor may be oriented along the navigation plane of the robotic vehicle based on the plane angle of the image sensor. For example, when the plane angle is large, the image sensor may be mounted on the robotic vehicle so that the short sides of the image sensor face the sides of the robotic vehicle. Conversely, if the plane angle is small, the image sensor may be mounted on the robotic vehicle so that the long sides of the image sensor face the sides of the robotic vehicle. Such mounting techniques may improve the quality of images captured during rotation and/or translation of the robotic vehicle.

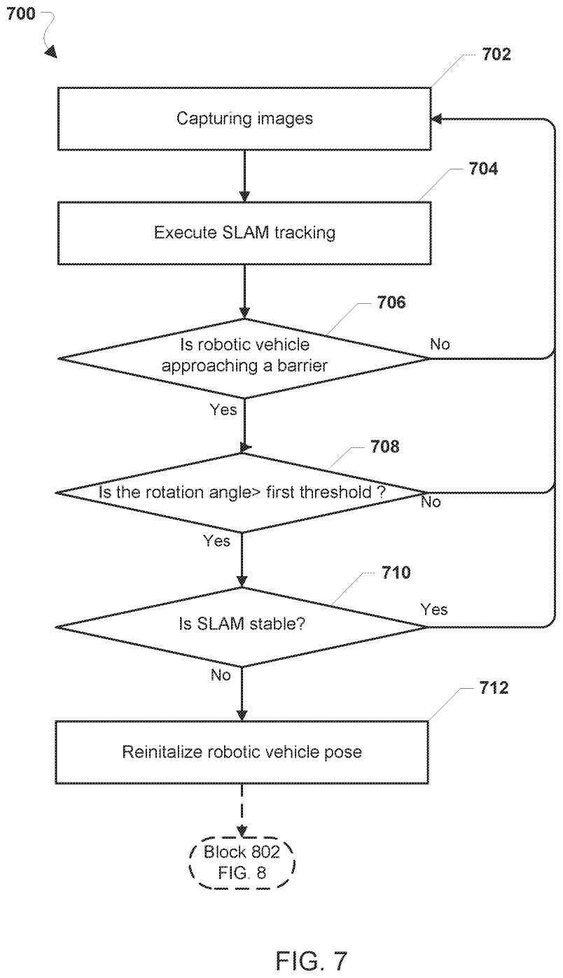

FIG. 7 illustrates a method 700 of performing robust navigation in a robotic vehicle according to various embodiments. With reference to FIGS. 1-7, a processor of a robotic vehicle (e.g., the processor 220, the processing device 310, the SoC 312, and/or the like) and hardware components and/or software components of the robotic vehicle may capture and process an image using an image sensor of the robotic vehicle (e.g., the image sensor 245).

In block 702, the rearward-facing image sensor of the robotic vehicle may capture images. In block 704, the processor of the robotic vehicle may execute simultaneous localization and mapping (SLAM) tracking using the captured images.

For each image captured, the processor may analyze the image to identify any discernible environmental features. Identified features may be compared between captured images to track changes. Based, at least in part, on changes to feature placement and scale between captured images, the processor may determine the location and direction of travel for the robotic vehicle.

In determination block 706, the processor may determine whether the robotic vehicle is approaching a barrier. In various embodiments, the processor may examine the distribution of points to determine whether the robotic vehicle is approaching a barrier. The robotic vehicle may also receive information from additional sensors such as infrared, sonar, and the pressure sensitive bumper to determine whether the robotic vehicle is approaching a barrier.

In response to determining that the robotic vehicle is not approaching a barrier (i.e., determination block 706=“No”), the processor may continue capturing images and performing SLAM tracking in block 702. If the robotic vehicle is not approaching a wall or other barrier, SLAM navigation should remain stable without further preparation.

In response to determining that the robotic vehicle is approaching a barrier (i.e., determination block 706=“Yes”), the processor may determine whether a rotation angle of the image sensor of the robotic vehicle exceeds a rotation threshold in determination block 708. As the robotic vehicle approaches the barrier, the captured images include a field of view that is 180 degrees rotated from the front of the robotic vehicle. When the robotic vehicle reaches the area near the barrier, the robotic vehicle may begin to rotate in anticipation of changing the direction of motion. The image sensor field of view will remain approximately 180 degrees counter to the front of the robotic vehicle, thus as the robotic vehicle rotates 90 degrees or more away from the barrier, the barrier will begin to come into the field of view of the image sensor.

In response to determining that the rotation angle of the image sensor does not exceed a rotation threshold (i.e., determination block 708=“No”), the processor may continue capturing images and performing SLAM tracking in block 702. For example, if the robotic vehicle side slips the barrier, or travels in parallel to the barrier, rather than turning around entirely (e.g., rotation angle is less than 90 degrees), the barrier may never come into full field of view of the image sensor. The image sensor may be able to continue capturing images that contain features the processor can identify and track.

In response to determining that the rotation angle of the image sensor of the robotic vehicle exceeds a rotation threshold (i.e., determination block 708=“Yes”), the processor may determine whether SLAM tracking is stable in determination block 710. For example, the processor may determine whether the features in images of the barrier captured by the image sensor are sufficient to enable the processor to determine its location. This may include determining whether the number of tracked features in the image exceeds a tracking threshold. The processor may further determine whether the number of mismatches of features between captured images is below a mismatch threshold. Similarly, an image sensor feature point cloud may be compared to output of other sensors of the robotic vehicle to determine whether matching of features is accurate.

In response to determining that SLAM tracking is stable (i.e., determination block 710=“Yes”) the processor may return to block 702 and continue capturing images and performing SLAM tracking. If the processor determines that SLAM navigation is stable, then despite the robotic vehicle's rotation, the image sensor is able to capture images of the barrier that are sufficiently detailed for the processor to continue performing SLAM navigation. This may occur in situations in which the barrier has distinguishing features that change along the barrier's length.

In response to determining that SLAM tracking is not stable (i.e., determination block 710=“No”), the processor may reinitialize a pose of the robotic vehicle in response to determining that SLAM tracking is not stable in block 712. If the processor is not able to determine that SLAM is stable, then the robotic vehicle is “lost” and must reinitialize its pose before continuing navigation.

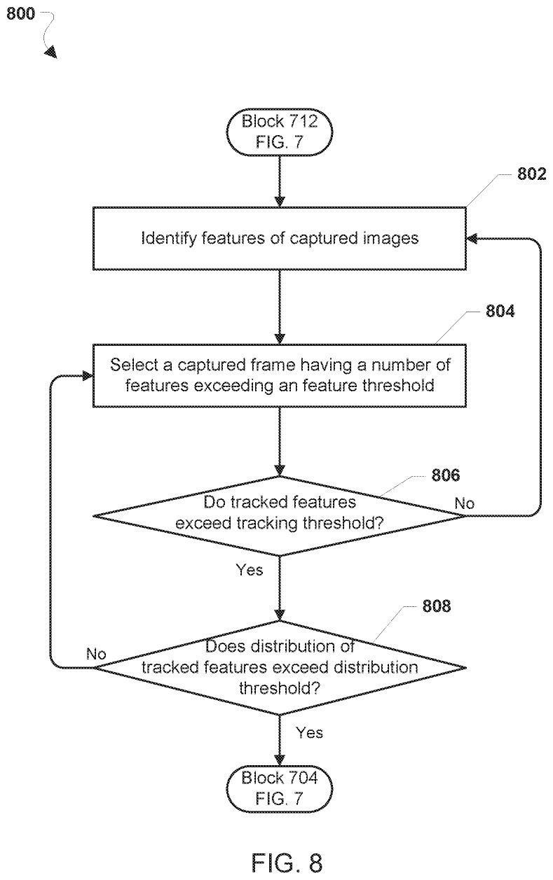

FIG. 8 illustrates a method 800 of pose reinitialization in a robotic vehicle according to various embodiments. With reference to FIGS. 1-8, a processor of a robotic vehicle (e.g., the processor 220, the processing device 310, the SoC 312, and/or the like and hardware components and/or software components of the robotic vehicle may capture and process an image using an image sensor of the robotic vehicle (e.g., the image sensor(s) 245). The processor may perform the method 800 following operations of block 712 of the method 700.

In block 802, the processor may identify features in the captured images. The processor may use a variety of image analysis techniques to identify prominent or distinguishable details or features within the captured images. The features may be environmental objects themselves or may be a combination of distinguishing details of those objects. For example, the presence of a tree in the distance may be a feature, but as the robotic vehicle's position becomes closer to the tree (e.g., the robotic vehicle moves in reverse), the tree may resolve into a number of distinguishing features.

In block 804, the processor may select a captured image having a number of features exceeding a feature threshold. As the features of each captured image are identified, they are counted. The first captured image having a number of identified features exceeding a feature threshold is selected. For example, the first captured image that has more than 50 identifiable features may be selected because there is a strong likelihood that at least some of these features may be tracked between the selected image and subsequent captured images.

In determination block 806, the processor may determine whether a number of tracked features of the selected image exceeds a tracking threshold. As the processor compares captured images to the selected image, the processor may count the number of features that correspond between images. These features are considered to be “tracked”. Features such as a flag pole, a building, or other object may be matched between the selected image and another captured image.

In response to determining that the number of tracked features of the selected image does not exceed the tracking threshold (i.e., determination block 806=“No”), the processor may again identify features in other captured images in block 802.

In response to determining that the number of tracked features of the selected image exceed the tracking threshold (i.e., determination block 806=“Yes”), the processor may determine whether the distribution of the tracked features exceeds a distribution threshold in determination block 808. As the robotic vehicle moves, the pixel distribution between image features may change. The closer that the robotic vehicle gets to an object or area, the larger the pixel distribution between features may become. Pose reinitialization may require that image features be sufficiently spaced from each other within the captured images that the processor can determine a shift in the robotic vehicle's position. The distribution threshold may be a number of pixels, or may be another measurement of distance.

In response to determining that the distribution of the tracked features does not exceed the distribution threshold (i.e., determination block 808=“No”), the processor may select another captured image block 804.

In response to determining that the distribution of the tracked features exceeds the distribution threshold (i.e., determination bloc k=“Yes”), the processor may execute SLAM tracking in block 704 of the method 700 as described.

Techniques for pose initialization may vary from those used for reinitialization, such as the method 800. Some robotic vehicles perform may pose initialization by taking images of test patterns having known dimensions and scale. The robotic vehicle processor may calculate posed based on the characteristics of the test pattern in the captured image. However, such techniques are not robust when the angle between the image sensor and the test pattern is large. Similarly, pose initialization techniques that rely on the output of a wheel encoder do not perform well on textured or carpeted surfaces. Inertial measurement units may be used to determine an initial pose of the robotic vehicle; however, such sensors require cross-calibration to obtain a relative pose and image sampling time, making such techniques processing intensive and somewhat unwieldy.

Various embodiments may overcome such problems with robotic vehicle pose initialization during the startup of operations using visual SLAM (vSLAM) techniques by using set of three-dimensional objects, such as spheres, in a predetermined “starting area,” such as mounted on a wall. The set of three-dimensional target objects may be rotationally symmetric shapes, such as spheres, and may have known dimensions (e.g., radius) and position. The spacing between the target objects may also be known to the processor and the target objects may be positioned such that at least two of the target objects are likely to be seen in a captured image at any given time. Spherical shapes may be particularly useful in vSLAM based pose initialization because the object will appear the same (i.e., as a circle in the image plane) from all angles, and the center of each sphere can be determined regardless of viewing orientation. Thus, with spherical target objects, regardless of the image sensor mounting angle or relative position of the robotic vehicle, an image of the target objects will include separated circular shapes that can be analyzed to determine their apparent diameter and the center, and thus separation distances and angles, making this technique very robust.

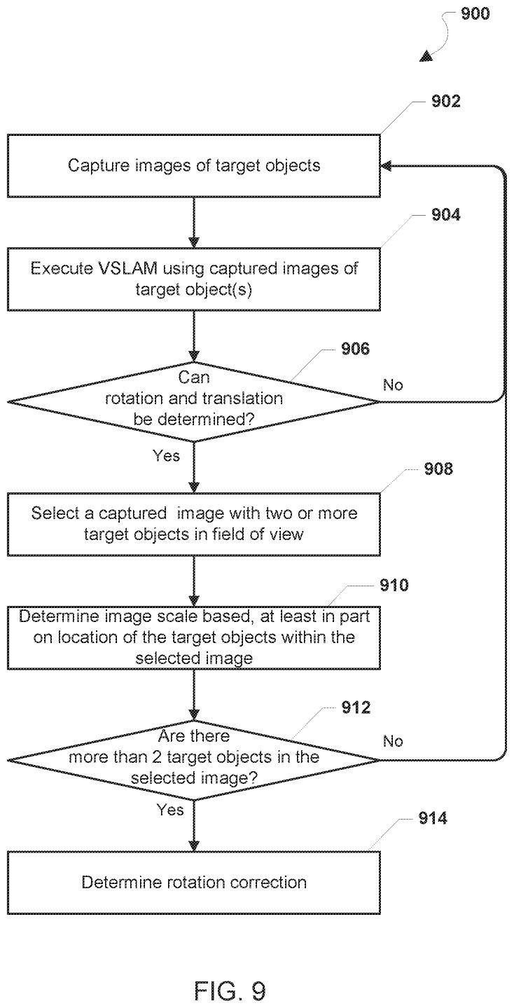

FIG. 9 illustrates a method 900 of pose initialization a robotic vehicle according to various embodiments. With reference to FIGS. 1-9, a processor of a robotic vehicle (e.g., the processor 220, the processing device 310, the SoC 312, and/or the like) and hardware components and/or software components of the robotic vehicle may capture and process an image using an image sensor (e.g., the image sensor 245).

In block 902, the image sensor may capture images of target objects. From a location in proximity or otherwise nearby a set of target objects, the image sensor of the robotic vehicle may capture images of the rotationally symmetric three-dimensional target objects (e.g., spheres with diameters and separation distances known to the processor). The target objects may be arranged such that the robotic vehicle image sensor can easily acquire images of at least two of the target objects. If the image sensor is unable to obtain an image of two or more of the target objects, the processor may instruct the various actuators to move the robotic vehicle to another location or pose and try again.

In block 904, the processor may execute visual simultaneous localization and mapping (VSLAM) using the captured images of the target objects. For example, the processor may identify features within each of the captured images and may attempt to track those features between subsequent images.

In determination block 906, the processor may determine whether the rotation angle of the image sensor can be determined. The processor may attempt to calculate the angle of rotation between the robotic vehicle and the target objects. Because the dimension, position, and location of the target objects is known, and stored in a memory of the robotic vehicle, the processor may be able to calculate the robotic vehicle's angle of rotation with reference to the target objects using the captured images.

In response to determining that the rotation angle of the image sensor cannot be (i.e., determination block 906=“No”) the processor may capture additional images of the target objects in block 902. Thus, if the processor is unable to determine the robotic vehicle's angle of rotation with reference to the target objects, the robotic vehicle may return to capturing images and performing VSLAM until an image is found from which the angle of rotation may be calculated.

In response to determining that the rotation angle of the image sensor can be determined (i.e., determination block 906=“Yes”), the processor may select a captured image having two or more target objects in a field of view of the image in block 908.

In block 910, the processor may determine an image scale based, at least in part, on a location of the target objects within the selected image. Because the dimension and position of the target objects relative to each other is already known, the processor of the robotic vehicle may calculate the scale of the images. The processor may compare the size and distribution of the target objects in the selected image to the stored dimension and position information for the target objects to determine the scale of the objects in the image.

In determination block 912, the processor may determine whether the selected image includes more than two target objects. This determination may be made during the selection of the captured image, during feature identification, or thereafter. If the selected image contains more than two target objects, additional information may be gained from the image.

In response to determining that the selected image does not include more than two target objects (i.e., determination block 912=“No”), the processor may continue capturing images of the target objects in block 902.

In response to determining that the selected image includes more than two target objects (i.e., determination block 912=“Yes”), the processor may determine a rotation angle correction in response to determining that the selected image includes more than two target objects in block 914. If the target objects are positioned within the same plane, then homography matrix based techniques may be employed by the processor to determine the rotation angle correction. If the target objects are not positioned in the same plane, then fundamental matrix techniques may be employed by the processor to determine the rotation angle correction.

Various embodiments enable the processor of the robotic vehicle to improve the initialization of an image sensor of the robotic vehicle. Various embodiments also improve the accuracy of the robotic vehicle's SLAM capabilities using a more accurately initialized robotic vehicle pose. Various embodiments also improve capability of a robotic vehicle to calibrate a monocular image sensor for use with SLAM determinations.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 700, 800, and 900 may be substituted for or combined with one or more operations of the methods 700, 800, and 900, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of navigating a robotic vehicle, comprising:
capturing images by a rearward-facing image sensor of the robotic vehicle;
executing, by a processor of the robotic vehicle, simultaneous localization and mapping (SLAM) tracking using the captured images;
determining, by the processor, whether the robotic vehicle is approaching a barrier;
determining, by the processor, whether a rotation angle of the image sensor of the robotic vehicle exceeds a rotation threshold in response to determining that the robotic vehicle is approaching a barrier;
determining, by the processor, whether SLAM tracking is stable in response to determining that the rotation angle of the image sensor exceeds the rotation threshold; and
reinitializing, by the processor, a pose of the robotic vehicle in response to determining that SLAM tracking is not stable.

2. The method of claim 1, wherein reinitializing the pose of the robotic vehicle comprises:
identifying, by the processor, features in the captured images;
selecting, by the processor, a captured image having a number of features exceeding a feature threshold;
determining, by the processor, whether a number of tracked features of the selected image exceeds a tracking threshold;
determining, by the processor, whether the distribution of the tracked features exceeds a distribution threshold in response to determining that the number of tracked features of the selected image exceeds a tracking threshold; and
executing, by the processor, SLAM tracking in response to determining that the distribution of the tracked features exceeds a distribution threshold.

3. The method of claim 1, further comprising initializing a pose of the robotic vehicle by:
capturing, by the image sensor, an image of target objects;
executing, by the processor, visual simultaneous localization and mapping (VSLAM) using the captured images of the target objects;
determining, by the processor, whether the rotation angle of the image sensor can be determined;
selecting, by the processor, a captured image having two or more target objects in a field of view of the image in response to determining that the rotation angle of the image sensor can be determined; and
determining, by the processor, an image scale based, at least in part, on a location of the target objects within the selected image.

4. The method of claim 3, further comprises:
determining, by the processor, whether the selected image includes more than two target objects; and
determining, by the processor, a rotation angle correction in response to determining that the selected image includes more than two target objects.

5. The method of claim 3, wherein the target objects are spherical.

6. The method of claim 3, wherein features comprise one or more of physical terrain, contour, lighting, building fixtures, and visual elements of an environment.

7. The method of claim 1, wherein executing SLAM tracking comprises:
identifying, by the processor, features in the captured images;
determining, by the processor, whether the identified features can be tracked between captured images;
determining, by the processor, whether a number of mismatches in features between captured images is below a mismatch threshold in response to determining that the identified features can be tracked between captured images; and
determining, by the processor, a pose of the robotic vehicle in response to determining that the number of mismatches in features between captured images is below the mismatch threshold.

8. The method of claim 1, wherein the rearward-facing image sensor is mounted on the robotic vehicle with the short sides of the image sensor facing the front and rear of the robotic vehicle if a plane angle of the image sensor is small.

9. The method of claim 1, wherein the rearward-facing image sensor is mounted on the robotic vehicle with the long sides of the image sensor facing the front and rear of the robotic vehicle if a plane angle of the image sensor is large.

10. A robotic vehicle, comprising:
a rearward facing image sensor configured for use in simultaneous localization and mapping (SLAM) tracking; and
a processor our coupled to the rearward facing image sensor and configured to:
capture images by the rearward-facing image sensor;
execute simultaneous localization and mapping (SLAM) tracking using the captured images;
determine whether the robotic vehicle is approaching a barrier;
determine whether a rotation angle of the image sensor of the robotic vehicle exceeds a rotation threshold in response to determining that the robotic vehicle is approaching a barrier;
determine whether SLAM tracking is stable in response to determining that the rotation angle of the image sensor exceeds the rotation threshold; and
reinitialize a pose of the robotic vehicle in response to determining that SLAM tracking is not stable.

11. The robotic vehicle of claim 10, wherein the processor is further configured to reinitialize the pose of the robotic vehicle by:
identifying features in the captured images;
selecting a captured image having a number of features exceeding a feature threshold;
determining whether a number of tracked features of the selected image exceeds a tracking threshold;
determining whether the distribution of the tracked features exceeds a distribution threshold in response to determining that the number of tracked features of the selected image exceeds a tracking threshold; and
executing SLAM tracking in response to determining that the distribution of the tracked features exceeds a distribution threshold.

12. The robotic vehicle of claim 10, wherein the processor is further configured to initialize a pose of the robotic vehicle by:
capturing, by the image sensor, an image of target objects;
executing visual simultaneous localization and mapping (VSLAM) using the captured images of the target objects;
determining whether the rotation angle of the image sensor can be determined;
selecting a captured image having two or more target objects in a field of view of the image in response to determining that the rotation angle of the image sensor can be determined; and
determining an image scale based, at least in part, on a location of the target objects within the selected image.

13. The robotic vehicle of claim 12, wherein the processor is further configured to:
determine whether the selected image includes more than two target objects; and
determine a rotation angle correction in response to determining that the selected image includes more than two target objects.

14. The robotic vehicle of claim 12, wherein the target objects are spherical.

15. The robotic vehicle of claim 12, wherein features comprise physical terrain, contour, lighting, building fixtures and visual elements of an environment.

16. The robotic vehicle of claim 10, wherein the processor is further configured to execute SLAM tracking by:
identifying features in the captured images;
determining whether the identified features can be tracked between captured images;
determining whether a number of mismatches in features between captured images is below a mismatch threshold in response to determining that the identified features can be tracked between captured images; and
determining a pose of the robotic vehicle in response to determining that the number of mismatches in features between captured images is below the mismatch threshold.

17. The robotic vehicle of claim 10, wherein the rearward-facing image sensor is mounted with the short sides of the image sensor facing the front and rear of the robotic vehicle if a plane angle of the image sensor is small.

18. The robotic vehicle of claim 10, wherein the rearward-facing image sensor is mounted with the long sides of the image sensor facing the front and rear of the robotic vehicle if a plane angle of the image sensor is large.

19. A non-transitory processor-readable medium having stored thereon process-executable instructions configured to cause a processor of a robotic vehicle to perform operations comprising:
executing simultaneous localization and mapping (SLAM) tracking using images captured by a rearward-facing image sensor of the robotic vehicle;
determining whether the robotic vehicle is approaching a barrier;
determine whether a rotation angle of the image sensor of the robotic vehicle exceeds a rotation threshold in response to determining that the robotic vehicle is approaching a barrier;
determining whether SLAM tracking is stable in response to determining that the rotation angle of the image sensor exceeds the rotation threshold; and
reinitializing a pose of the robotic vehicle in response to determining that SLAM tracking is not stable.

20. The non-transitory processor-readable media of claim 19, wherein the stored processor-executable instructions are further configured to cause the processor of the robotic vehicle to perform operations such that reinitializing the pose of the robotic vehicle comprises:
identifying features in the captured images;
selecting a captured image having a number of features exceeding a feature threshold;
determining whether a number of tracked features of the selected image exceeds a tracking threshold;
determining whether the distribution of the tracked features exceeds a distribution threshold in response to determining that the number of tracked features of the selected image exceeds a tracking threshold; and
executing SLAM tracking in response to determining that the distribution of the tracked features exceeds a distribution threshold.

21. The non-transitory processor-readable media of claim 19, wherein the stored processor-executable instructions are further configured to cause the processor of the robotic vehicle to perform operations initializing a pose of the robotic vehicle comprising:
executing visual simultaneous localization and mapping (VSLAM) using captured images of the target objects;
determining whether the rotation angle of the image sensor can be determined;
selecting a captured image having two or more target objects in a field of view of the image in response to determining that the rotation angle of the image sensor can be determined; and
determining an image scale based, at least in part, on a location of the target objects within the selected image.

22. The non-transitory processor-readable media of claim 21, wherein the stored processor-executable instructions are further configured to cause the processor of the robotic vehicle to perform operations further comprising:
determining whether the selected image includes more than two target objects; and
determining a rotation angle correction in response to determining that the selected image includes more than two target objects.

23. The non-transitory processor-readable media of claim 21, wherein the target objects are spherical.

24. The non-transitory processor-readable media of claim 21, wherein the stored processor-executable instructions are further configured to cause the processor of the robotic vehicle to perform operations such that features comprise one or more of physical terrain, contour, lighting, building fixtures and visual elements of an environment.

25. The non-transitory processor-readable media of claim 19, wherein the stored processor-executable instructions are further configured to cause the processor of the robotic vehicle to perform operations such that executing SLAM tracking comprises:
identifying features in the captured images;
determining whether the identified features can be tracked between captured images;
determining whether a number of mismatches in features between captured images is below a mismatch threshold in response to determining that the identified features can be tracked between captured images; and
determining a pose of the robotic vehicle in response to determining that the number of mismatches in features between captured images is below the mismatch threshold.

26. A robotic vehicle, comprising:
means for capturing images;
means for executing simultaneous localization and mapping (SLAM) tracking using the captured images;
means for determining whether the robotic vehicle is approaching a barrier;
means for determining whether a rotation angle of the image sensor of the robotic vehicle exceeds a rotation threshold in response to determining that the robotic vehicle is approaching a barrier;
means for determining whether SLAM tracking is stable in response to determining that the rotation angle of the image sensor exceeds the rotation threshold; and
means for reinitializing a pose of the robotic vehicle in response to determining that SLAM tracking is not stable.

27. The robotic vehicle of claim 26, wherein means for reinitializing the pose of the robotic vehicle comprises:
means for identifying features in the captured images;
means for selecting a captured image having a number of features exceeding a feature threshold;
means for determining whether a number of tracked features of the selected image exceeds a tracking threshold;
means for determining whether the distribution of the tracked features exceeds a distribution threshold in response to determining that the number of tracked features of the selected image exceeds a tracking threshold; and
means for executing SLAM tracking in response to determining that the distribution of the tracked features exceeds a distribution threshold.

28. The robotic vehicle of claim 26, further comprising means for initializing a pose of the robotic vehicle comprising:
means for capturing an image of target objects;
means for executing visual simultaneous localization and mapping (VSLAM) using the captured images of the target objects;
means for determining whether the rotation angle of the image sensor can be determined;
means for selecting a captured image having two or more target objects in a field of view of the image in response to determining that the rotation angle of the image sensor can be determined; and
means for determining an image scale based, at least in part, on a location of the target objects within the selected image.

29. The robotic vehicle of claim 28, further comprising:
means for determining whether the selected image includes more than two target objects; and
means for determining a rotation angle correction in response to determining that the selected image includes more than two target objects.

30. The robotic vehicle of claim 28, wherein the target objects are spherical.
